(19) United States
(12) Patent Application Publication
(10) Pub. No.: US 2023/0089825 A1
(43) Pub. Date: Mar. 23, 2023

(54) SYSTEMS AND METHODS FOR GENERATING SHOPPING CHECKOUT LISTS

(71) Applicants: Yair Cleper, Petah Tikva (IL); David Ring, Petah Tikva (IL)

(72) Inventors: Yair Cleper, Petah Tikva (IL); David Ring, Petah Tikva (IL)

(21) Appl. No.: 17/909,415

(22) PCT Filed: Mar. 4, 2021
(86) PCT No.: PCT/IB21/51833

§ 371 Date: Sep. 5, 2022

Related U.S. Application Data
(60) Provisional application No. 62/985,420, filed on Mar. 5, 2020.

(51) Int. Cl. G06Q 30/0601; G06V 20/52; G01G 19/40

(52) U.S. Cl. CPC G06Q 30/0633; G06V 20/52; G01G 19/40

(57) ABSTRACT

A system for generating a shopping checkout list of items selected by a shopper in a store including: in-store security cameras; a cart scanner and a cart analyzer configured to generate a shopping checkout list based on the data received from the cart scanner; and a shopping list builder (SLB) configured to record images from the security cameras of the shopper's activity in the store to form recorded images, wherein, when the SLB requires verification of an item in the generated shopping checkout list, the SLB is further configured to analyze the recorded images to determine selection of an item by a shopper to thereby verify the item on the shopping checkout list.

### CROSS REFERENCE TO RELATED APPLICATIONS

This is a 371 application from international patent application No. PCT/IB2021/051833 filed Mar. 4, 2021, which claims the benefit of priority from U.S. Provisional patent application No. 62/985,420 filed Mar. 5, 2020 and which is incorporated herein by reference in its entirety.

### FIELD

Embodiments disclosed herein relate to systems and methods for self-checkout from a store and more specifically for generating a shopping checkout list to enable self-checkout.

### BACKGROUND

Current systems and methods for self-checkout in stores tend to take two approaches for generating the list of items selected by the shopper. A first approach relies on the shopper to scan or otherwise indicate the items selected. This approach tends to slow down the shopping process and is open to error or abuse as shoppers may not scan all of the items in their shopping cart. A second approach relies on systems for monitoring shoppers that detects selected items as these are taken off the shelf and/or placed in the cart. These monitoring systems typically require expensive and complex installation of tens or hundreds of dedicated on-shelf or in-cart monitoring devices such as cameras or tracking labels placed on all the products.

There is therefore a need for, and it would be advantageous to have a system and method for making the self-checkout process faster and less prone to abuse or error but without requiring expensive retrofitting of the store with dedicated monitoring hardware.

### SUMMARY

Exemplary embodiments disclosed herein relate to a system and method for generating a shopping checkout list to enable self-checkout. As described herein, the shopping checkout list is generated without the need for scanning of selected items, by the shopper or a cashier, enabling shoppers to fill a cart, present the cart for analysis and generation of a shopping checkout list, pay and leave.

The system as disclosed herein in some embodiments makes use of a combination of indicators to determine whether a shopper has selected an item for purchase in order to add the item to a generated shopping checkout list. These indicators may be derived using one or more of a checkout scanning device, analyzed images from existing in-store security cameras, a software store map, customer and cart position tracking, and store inventory data. A shopping list builder and cart analyzer may provide for generation of the checkout list using the above indicators and by suggesting alterations or calling on a “cloud cashier” for human assistance. In some embodiments, a verifier system may provide further verification of the list generated by the cart analyzer.

The system operates without requiring retrofitting of the store with large numbers of dedicated monitoring cameras and sensors since use is made of existing security cameras optionally supplemented with a minimal amount of shelf/aisle cameras.

Exemplary embodiments as described herein enable a shopping experience that is familiar to shoppers, who are able to move around the store and place items in a cart without needing to stop and scan all of the items and without needing to scan all of the items individually at a checkout counter.

In some exemplary embodiments a system for generating a shopping checkout list of items selected by a shopper in a store includes: in-store security cameras; a shopping list builder (SLB) adapted to analyze images from the security cameras to determine selection of items by a shopper and to generate a shopping checkout list; and a checkout analyzer system for verifying the generated shopping checkout list. In some embodiments, the SLB includes a store mapper and wherein the determined selection of items is limited by items in the vicinity of the shopper in the store as provided by the store mapper.

In some embodiments, selected items are placed in a cart to form contents of the cart and wherein verifying the generated shopping checkout list includes analyzing the contents of the cart by the checkout analyzer system to determine whether the contents of the cart match the generated shopping checkout list. In some embodiments, the cart includes a cart ID and wherein the cart is tracked by the SLB by identification of the cart ID and wherein the cart is associated with the shopper based on proximity and usage of the cart by the shopper.

In some embodiments, analysis of the images from the security cameras is performed using machine vision techniques. In some embodiments, when the contents of the cart do not match the generated shopping checkout list, the checkout analyzer suggests items that may be in the cart that do not appear on the shopping checkout list.

In other exemplary embodiments, method for generating a verified shopping checkout list of items selected by a shopper in a store includes: by a shopper, selecting items for purchase; by a shopping list builder (SLB), analyzing images from in-store security cameras to determine the selection of items by the shopper; by the SLB, generating a shopping checkout list based on the image analysis; and by a checkout analyzer system, verifying the generated shopping checkout list. In some embodiments, selected items are placed in a cart to form contents of the cart and wherein verifying the generated shopping checkout list includes analyzing the contents of the cart by the checkout analyzer system to determine whether the contents of the cart match the generated shopping checkout list.

In some embodiments, when the contents of the cart do not match the generated shopping checkout list, the checkout analyzer suggests items that may be in the cart that do not appear on the shopping checkout list.

In some embodiments, a system for generating a shopping checkout list (SCL) of items selected by a shopper in a store includes: in-store security cameras; and a shopping list builder (SLB) configured to analyze images from the in-store security cameras to determine selection of items by a shopper and to generate the SCL. In some embodiments, the system further includes a cart scanner and a cart analyzer configured to verify the generated SCL based on the data received from the cart scanner.

In some embodiments, selected items are placed in a cart to form contents of the cart and wherein the configuration to verify the generated SCL includes a configuration to analyze contents of the cart by the cart analyzer to determine whether the contents of the cart match the generated SCL. In some embodiments, the cart includes a cart ID, wherein the cart is tracked by the SLB by identification of the cart ID, and wherein the cart is associated with the shopper based on proximity and usage of the cart by the shopper.

In some embodiments, when the contents of the cart do not match the generated SCL, the cart analyzer is configured to suggest items that may be in the cart and which do not appear on the SCL. In some embodiments, when the contents of the cart do not match the generated SCL, the cart analyzer is configured to forward suggestions for items that may be in the cart and which do not appear on the SCL to a cloud cashier. In some embodiments, the SLB includes a store mapper and wherein the determined selection of items is limited by items in the vicinity of the shopper in the store as provided by the store mapper.

In some embodiments, the cart scanner includes a camera and/or a weight sensor for providing data for analysis of the cart by the cart analyzer. In some embodiments, analysis of the images from the security cameras and/or the scanner camera is performed using machine vision techniques. In some embodiments, the system further includes a verifier system configured to verify the generated checkout list.

In some embodiments, the system further includes a shelf scale configured to transmit to the SLB a removed weight of weighed goods selected by the shopper. In some embodiments, the system further includes a printer scale configured to transmit to the SLB the weight of weighed goods as selected by a shopper and placed on the printer scale.

In some embodiments, a system for generating a shopping checkout list (SCL) of items selected by a shopper in a store includes: a plurality of in-store security cameras; a cart scanner; a cart analyzer configured to generate a SCL based on the data received from the cart scanner; and a shopping list builder (SLB) configured to record images from the security cameras of activity of the shopper in the store to form recorded images, wherein, when the SLB requires verification of an item in the generated SCL, the SLB is further configured to analyze the recorded images to determine selection of an item by a shopper to thereby verify whether the item is on the SCL.

In some embodiments, when the SCL is determined to be incomplete, the cart analyzer is configured to suggest items that may be in the cart that do not appear on the SCL. In some embodiments, when the SCL is determined to be incomplete, the cart analyzer is configured to forward suggestions for items that may be in the cart that do not appear on the SCL to a cloud cashier. In some embodiments, the cart scanner includes a camera and/or a weight sensor for providing data for analysis of the cart. In some embodiments, analysis of the images from the security cameras and/or the scanner camera is performed using machine vision techniques. In some embodiments, the system further includes a verifier system configured to verify the generated checkout list.

In some embodiments, a method for generating a shopping checkout list (SCL) of items selected by a shopper in a store includes: by a shopper, selecting items for purchase; by a shopping list builder (SLB), analyzing images from security cameras to determine the selection of items by the shopper; by the SLB, generating a SCL based on the image analysis; and by a cart analyzer system, comparing the selected items to the generated SCL to thereby verify the generated SCL.

In some embodiments, a method for generating a shopping checkout list (SCL) of items selected by a shopper in a store includes: by a shopper, selecting items for purchase; by a shopping list builder (SLB), recording images from security cameras of activity of the shopper in the store to form recorded images; providing the selected items to a cart scanner for scanning; determining by a cart analyzer of determined selected items based on scanning data from the cart scanner; forming a SCL based on the determined selected items; and when the SLB requires verification of a determined selected item in the generated SCL, analyzing by the SLB of the recorded images to determine selection of the determined selected item by a shopper to thereby verify the determined selected item on the SCL.

In some embodiments, when the SCL is determined to be incomplete, suggesting items by the cart analyzer that may selected items that do not appear on the SCL. In some embodiments, when the SCL is determined to be incomplete, forwarding suggestions by the cart analyzer for items that may be selected items that do not appear on the SCL to a cloud cashier.

The term “cart” as used herein may also refer to a shopping basket, trolley, bag, box, or other receptacle including holding of items by hand by a shopper in a store to hold items selected for purchase. The term “item”: as used herein refers to goods offered for purchase in a store. Selecting of items implies that the shopper has removed items from their position in the store and now holds these selected items apparently intending to purchase them.

This Summary is provided to introduce a selection of concepts in a simplified form that are further described below in the Detailed Description below. It may be understood that this Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings.

### BRIEF DESCRIPTION OF THE DRAWINGS

Aspects, embodiments and features disclosed herein will become apparent from the following detailed description when considered in conjunction with the accompanying drawings. Like elements may be numbered with like numerals in different figures, wherein:

FIG. 1A shows an exemplary schematic drawing of a system for generating a shopping checkout list according to some embodiments;

FIG. 1B shows an illustrative plan view of a store that uses a system for generating a shopping checkout list according to some embodiments;

FIG. 1C shows an exemplary shopping checkout list data structure according to some embodiments;

FIG. 2 shows an exemplary flowchart of a process for generating a shopping checkout list according to some embodiments.

FIG. 3 shows an exemplary flowchart of a process for generating a shopping checkout list according to some embodiments.

### DETAILED DESCRIPTION

Aspects of this disclosure may provide a technical solution to the challenging technical problem of self-checkout and may relate to a system for generating a shopping checkout list (SCL) to enable self-checkout with the system having at least one processor (e.g., processor, processing circuit or other processing structure described herein), including methods, systems, devices, and computer-readable media. For ease of discussion, example methods are described below with the understanding that aspects of the example methods apply equally to systems, devices, and computer-readable media. For example, some aspects of such methods may be implemented by a computing device or software running thereon. The computing device may include at least one processor (e.g., a CPU, GPU, DSP, FPGA, ASIC, or any circuitry for performing logical operations on input data) to perform the example methods. Other aspects of such methods may be implemented over a network (e.g., a wired network, a wireless network, or both).

As another example, some aspects of such methods may be implemented as operations or program codes in a non-transitory computer-readable medium. The operations or program codes may be executed by at least one processor. Non-transitory computer readable media, as described herein, may be implemented as any combination of hardware, firmware, software, or any medium capable of storing data that is readable by any computing device with a processor for performing methods or operations represented by the stored data. In a broadest sense, the example methods are not limited to particular physical or electronic instrumentalities, but rather may be accomplished using many differing instrumentalities.

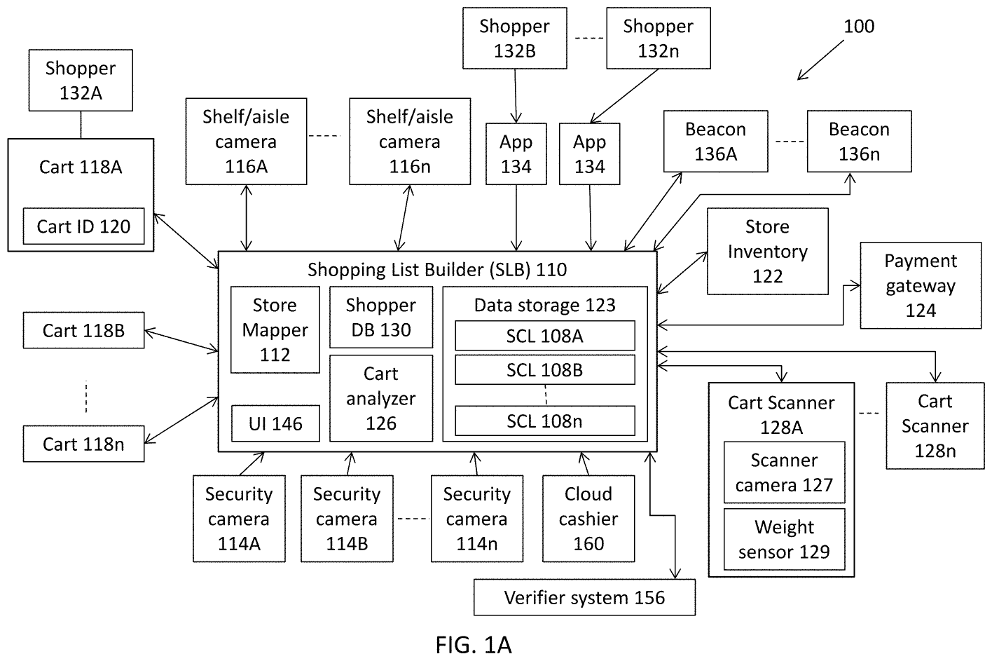

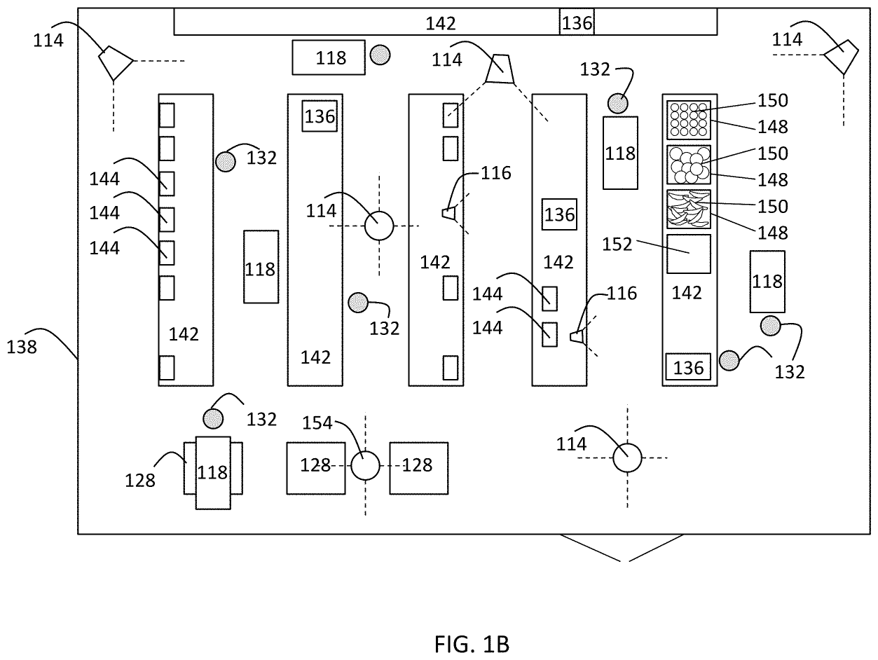

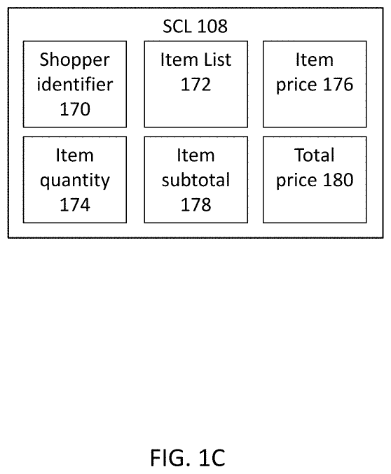

Exemplary embodiments relate to a system and method for generating a shopping checkout list (SCL) to enable self-checkout. FIG. 1A shows an exemplary schematic drawing of a SCL system 100 and FIG. 1B shows an illustrative plan view of a store that utilizes an SCL system. FIG. 1C shows an exemplary SCL data structure. As shown in FIGS. 1A and 1B, a SCL system 100 may include the following components:

Shopping list builder (SLB) 110 is a computing device as defined herein. SLB 110 gathers inputs from the other components of SCL system 100 and generates SCLs 108 based on analysis of a shopper cart 118 and/or shopper activity in a store 138. SCLs 108 may be stored in data storage 123 of SLB 110. FIG. 1A shown SCLs 108A, 108B, . . . 108n indicating that multiple SCLs 108 may be generated and stored by system 100.

SLB 110 may include a cart analyzer 126 that may use machine vision and/or weight analysis based on data received from a cart scanner 128 to determine the items 144 in a cart 118. SLB 110 may include a store mapper 112 for mapping of the store 138 layout and positioning of items 144 in store 138. SLB 110 may also include a shopper database (DB) 130 including a listing of known shoppers 132A-n and related shopper data as described further below. SLB 110 may further include a user interface (UI) 146 for interaction of a user, such as store personnel, with SLB 110. In some embodiments, UI 146 may include a push notification engine (not shown) for sending notifications to store personnel.

As shown in FIG. 1C, SCL 108 is a data structure and may include one or more of a shopper name or shopper identifier 170, a list 172 of selected items that have been selected for purchase by shopper 132, the quantity 174 of each item selected, the price 176 of each selected item, the item subtotal price 178 (quantity multiplied by item price), and the total price 180 of all selected items (a sum of all subtotals). SCL 108 may further include data about the shopper 132 behavior related to selected items including but not limited to position in store where an item was selected, items returned to shelves, item weight, item subtotal weight, total weight of all items, item images, images of shopper selecting items, and so forth. The accuracy of SCL 108 is evaluated by comparing SCL 108 to the contents of cart 118. A verified SCL 108 refers to an SCL 108 that has been verified by the systems disclosed herein as being accurate.

Cart analyzer 126 is in data communication with cart scanners 128A-n for analysis of filled carts 118A-n. Cart scanners 128 may include one or more scanner cameras 127 and/or weight sensors 129. In some embodiments, each of cart scanners 128 includes a display (not shown). In some embodiments, carts may be positioned on, in, or under scanners 128 for analysis depending on the design of scanner 128.

Security cameras 114A-n are present in store 138 (and are therefore referred to as “in-store security cameras”) for monitoring and recording activities in store 138. Multiple security cameras 114 are typically deployed such that all parts of store 138 may be monitored. The term “security camera” as used herein may refer to any camera that is deployed in the area of the store 138 for another purpose aside from generating SCLs. In some embodiments, security cameras 114 may be preexisting in store 138 before installation of some other components of system 100.

In some embodiments, shelf/aisle cameras 116A-n may be provided for closer monitoring of shopper 132 activity, or where security cameras 114 do not provide sufficient coverage or sufficient resolution. In some embodiments, one or more checkout cameras 154 may be provided for monitoring and verification of shoppers at checkout.

Carts 118 may be used by shoppers 132 to collect items 144A-n as known in the art. In some embodiments, each of carts 118 may include a cart identification (ID) 120. Cart ID 120 may include a unique identifier for the specific cart that may be wirelessly tracked throughout store 138. Non-limiting examples of cart ID 120 may include: barcode, QR code, RFID, tracking beacons and so forth;

In some embodiments, shoppers 132 may install a shopping app 134 (also referred to herein as “app” 134) on a computing device such as a smartphone (not shown) held by shopper 132. App 134 may make use of the hardware and software of the smartphone to fulfil its functionality. The functionality and use of shopping app 134 is described further below.

In some embodiments, location beacons 136A-n also known as proximity beacons may be provided to enable determining of the position in store 138 of apps 134 and/or carts 118 based on the distance of apps 134 and/or carts 118 from beacons 136. Non-limiting examples of beacon standards used include Bluetooth, Bluetooth Low Energy, WiFi, and so forth.

In some embodiments, a store inventory server 122 may contain a database (DB) of the items 144 offered for sale at store 138 including item data about each of items 144. Item data may include but is not limited to pricing, weight, item images, and so forth.

In some embodiments, a payment gateway 124 is provided and may include means for settling payment for items 144 purchased in store 138.

In some embodiments, a verifier system 156 is provided and may be a 3^{rd} party system for verification that SCL 108 generated for shoppers 132A-n is accurate and for suggesting, inserting or deleting any missing, duplicated or incorrect items on SCL 108.

In some embodiments, a cloud cashier system 160 provides for a remote human review of a generated SCL 108. Cloud cashier system includes a graphical user interface (not shown) for enabling interaction by a human reviewer with SCL 108. Although one cloud cashier system 160 is shown it should be appreciated that multiple interfaces may be provided to cloud cashier system 160 enabling multiple human operators to review unidentified or suggested items for incomplete SCLs 108. Cloud cashier system may also be used for authorizing a purchase by a human reviewer such as when alcohol has been purchased or a security tag needs authorization to be disabled.

As shown in FIG. 1B, store 138 includes shelves 142 stocked with items 144 for sale with aisles 140 in between shelves 142. For simplicity, not all parts of FIG. 1B are labelled. Security cameras 114 may typically be positioned to provide visual coverage of all or most of store 138. Shoppers 132 walk around store 138 selecting items 144 for purchase and may make use of carts 118 for placing of items 144 to be purchased therein. In some embodiments, shelf/aisle cameras 116 may be positioned within or on shelves 142 for closer monitoring of shopper 132 activity. In some embodiments, beacons 136 may track shopper devices (via apps 134) and/or carts 118. Prior to exiting store 138, shoppers 132 pass through cart analyzer 126 including scanners 128.

Store 138 may also include means for pricing of weighed goods 150. Weighed goods 150 refers to items 144 that are purchased by weight. Non-limiting examples of weighed goods include fruit, vegetables, baked goods, meat, cheese and so forth. In some embodiments, weighed goods 150 may be positioned for sale on a shelf scale 148. As weighed goods 150 are removed from shelf scale 148, the change (reduction) in weight may be recorded for calculation of the cost of the weighed goods 150 removed. The calculated cost of the selected weighed goods 150 may be added to SCL 108 as described further below.

In some embodiments, shoppers 132 may place weighed goods on printer scale 152 where the weight of the weighed goods 150 may be recorded, or alternatively where a scannable price label for the weighed goods 150 may be printed. Shelf scale 148 and printer scale 152 may be in wired or wireless data communication with SLB 110. The calculated cost of the selected weighed goods 150 may be added to SCL 108 as described further below.

It should be appreciated that some of the components listed above are present as a plurality and are numbered A, B, n and so forth. For example, multiple security cameras 114 are present in store 138 and these have been numbered 114A, 114B, and 114n. A number range is indicated as starting from “A” up to “n” where the number “n” may be different for each component. In all cases the number of components shown is illustrative and optionally any reasonable number may be present depending on the size of the store 138, and the illustrations and numbers of components should therefore not be considered limiting.

SLB 110 may make use of machine vision techniques to analyze the images from security cameras 114 to identify one or more of specific carts 118 (via cart ID 120), shoppers 132, shopper behavior, shopper position, and items 144 in the images received from security cameras 114. In some embodiments, images from shelf/aisle cameras 116 may also used. SLB 110 may thus able to determine that a specific shopper 132 positioned in a known position within store 138 is interacting with and/or placing a specific item 144 into a specific cart 118 to thereby generate a SCL 108 associated with the shopper 132 and the cart 118. The determination of the item 144 selected by a shopper 132 may be aided by the store map that includes data of the position of items 144 on shelves 142.

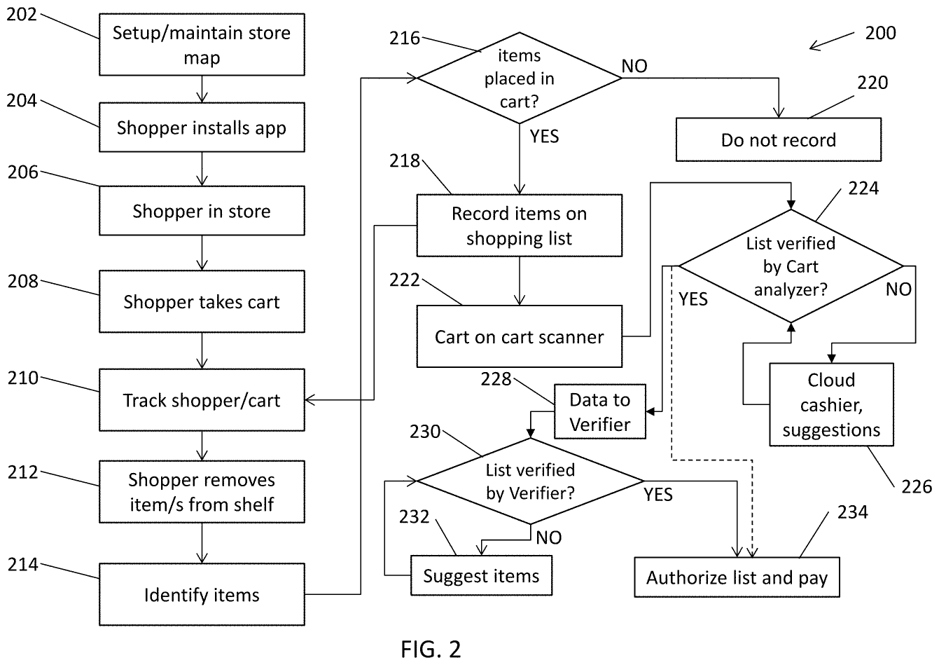

FIG. 2 shows an exemplary flowchart of a process (method) numbered 200 for generating an SCL 108 according to some embodiments. Process 200 utilizes SCL system 100 as described above. As shown in FIG. 2, in an initial step 202, SCL system 100 is prepared for use within store 138. The initial setup may include one or more of: connection of store security cameras 114 and shelf/aisle cameras 116 to SLB 110, setup of a store map, setup of cart IDs 120, and connection of SLB 110 to store inventory management 122, to cart scanners 128, verifier system 156 and payment gateway 124. It should be appreciated that SLB 110 includes adaptable interfaces for integration with 3^{rd} party systems such as store inventory management 122, verifier system 156, and payment gateway 124.

The store map may be defined using UI 146 of SLB 110 and includes a graphical plan representation of the physical location within store 138 of shelves 142 and items 144 on shelves 142. Views from cameras 114 and 116 may then be correlated with the store map using the UI 146 of SLB 110. In some embodiments, beacons 136 may be installed in store 138 and may be configured in SLB 110 including indicating positions of beacons 136 on the store map. It should be appreciated that system 100 may be operable using only the views from security cameras 114, and shelf/aisle cameras 116 are only required in situations where security cameras 114 do not provide sufficient store coverage or sufficient resolution.

In optional step 204, shoppers 132 may install app 134 and may register for use of system 100. Data of registered shoppers 132 may be stored in shopper DB 130. Shopper data may include but is not limited to: a current SCL, previous SCLs, current position in store, previous in-store routes used, cart in current use, and so forth. Step 204 is optional and system 100 is operable if shoppers 132 don't use app 134.

In step 206, a shopper 132 enters store 138. Shopper 132 is visible to cameras 114 and/or 116 and SLB 110 may perform anonymous facial or other visual recognition of shopper 132 based on images from cameras 114 and 116 for the purposes of tracking shopper 132 while shopper 132 is in the store 138. In some embodiments, SLB 110 may group together shoppers 132 that move around store 138 together and/or share a specific cart 118 and the item selections of the identified group of shoppers may be combined into a single SCL 108. As used herein, shopper 132 may refer to such an identified group of shoppers 132. Where shopper 132 is using app 134, app 134 initiates a wireless data connection to SLB 110 such that SLB 110 is able to associate the generated SCL 108 with the shopper 132 using app 134. In some embodiments, SLB 110 may use app 134 interactions with beacons 136 to confirm shopper's 132 position in store 138 as reported by beacons 136 or app 134.

In step 208, shopper 132 takes a cart 118 for use in store 138. Cart 118 may be identified using cart ID 120 by SLB 110 based on visual recognition of images from cameras 114 and 116 and cart 118 may be associated with shopper 132 until shopper 132 completes a current shopping session (such as by leaving the store). In step 210, the shopper 132 and cart 118 may be tracked as they move about store 138 to determine a shopper location. As above, store map may include item locations in store 138 and SLB 110 may narrow down the list of items 144 in the vicinity of shopper 132 that could possibly be selected by shopper 132. In some embodiments, the item 144 purchase history of shopper 132 in shopper DB 130 may be consulted to narrow down the items 44 that shopper 132 may have selected.

In step 212, shopper 132 interacts with one or more items 144 from a shelf 142. In step 214, SLB 110 may use the images from cameras 114 and/or 116 and machine vision techniques to identify the shopper activity and the item 144 selected by the shopper 132. SLB 110 may also determine whether more than one of an item 144 was selected. In some embodiments, where an item 144 was not identified (such as when the item 144 was obscured by a shopper 132 or cart 118, SLB 100 may register an unidentified item and the store location so that cart analyzer 126 may suggest what the unidentified item might be at checkout.

In some embodiments, where multiple items 144 are very similar in appearance and SLB 110 cannot determine which item 144 was selected, all of the item 144 options are recorded by SLB 110. In some embodiments, shopper 132 is given the option via app 134 to choose between the item 144 options, immediately following the item 144 selection, or at checkout. In some embodiments, the item 144 options are communicated to cart analyzer 126 for detection and verification at checkout or for selection by the shopper 132 at checkout. In some embodiments, the item 144 options may be assigned a likelihood score based on factors including but not limited to shopper history, or other currently selected items 144. In some embodiments, exceeding a defined score threshold may determine whether SLB 110 records the highest scoring item 144 onto SCL 108. In some embodiments, the likelihood score may be communicated to cart analyzer 126 for detection and verification at checkout. In some embodiments, where item 144 location continually results in difficulty of identification by SLB 110, SLB 110 may notify store 138 personnel such as via UI 146.

In some embodiments, where an item 144 was clearly imaged, but is not listed in store inventory 122, SLB 110 may flag the item for store personnel such as via UI 146. In some embodiments, where an item 144 was identified, but is missing information from store inventory 122, SLB 110 may flag the item for store personnel such as via UI 146. It should be appreciated that SLB 110 thus assists with management of dynamically changing store inventory.

In decision step 216, SLB 110 may determine using machine vision techniques how the shopper 132 interacts with goods 144, such as whether the selected item 144 was placed into cart 118, remains held by shopper 132, was replaced onto shelf 142, was passed to another shopper 132, was dropped, or was abandoned in another location. In some embodiments, shoplifting activity may be detected and reported to store 138 personnel such as via UI 146. If item 144 was placed into cart 118 or is held by shopper 132 then in step 218, SCL 108 associated with shopper 132 may be updated with the item 144 selected.

Where weighed goods 150 are selected, shelf scales 148 may transmit the removed weight of weighed goods 150 as selected by a shopper 132 to SLB 110. The price of the selected weighed goods 150 may then be calculated and added to SCL 108. Where weighed goods 150 are placed on printer scale 152, printer scale 152 may transmit the weight of weighed goods 150 as selected by a shopper 132 and placed on printer scale 152 to SLB 110. The price of the selected weighed goods 150 may then be calculated and added to SCL 108. Alternatively, printer scale 152 may print a price label for scanning by app 134 for adding to SCL 108.

Where shopper 132 is using app 134, app 134 may be updated to display the current SCL 108 including selected items 144.

If SLB 110 determines in step 216 that the item 144 was replaced onto a shelf 142 or otherwise abandoned by shopper 132, then in step 220, the item 144 is not recorded on SCL 108. In some embodiments, where SLB 110 determines that a shopper 132 has replaced an item 144 in an incorrect position in the store 138 for that item 144, SLB 110 may alert store personnel via UI 146. In some embodiments, SLB 110 identifies non-selective interaction by a shopper 132 with goods 144 such as but not limited to knocking over goods 144 or helping another shopper 132 by passing goods 144 to them. Steps 210, 212, 214, 216, and 218/220 are repeated as shopper 132 moves around store 138 and selects items 144 to thereby cause system 100 to generate SCL 108.

In some embodiments, app 134 may notify shopper 132 of promotions related to items 144 that are positioned near to shopper's 132 current location. In some embodiments, app 134 may notify shopper 132 of promotions or related purchase information related to items 144 that have already been selected (as per the generated SCL 108).

In step 222, shopper 132 reaches a cart scanner 128. SLB 110 provides the determined SCL 108 for shopper 132 to cart analyzer 126. In step 224, cart analyzer 126 using scanner 128, analyzes cart 118 and the provided SCL 108 to verify whether the provided SCL 108 matches the contents of cart 118 as determined by cart analyzer 126. The analysis by cart analyzer 126 of cart 118 is based on data provided by scanner 128 including loaded cart weight as measured by weight sensor 129, and visual analysis of cart 118 by scanner camera 127. The analysis by cart analyzer 126 of cart 118 may also be based on shopper 132 historical shopping data, general shopper buying trends, and so forth.

In step 226, where cart analyzer 126 determines that the provided SCL 108 is incomplete, i.e. may not match the contents of cart 118, or where there is uncertainty as to the contents of the cart as determined by cart analyzer 126, in some embodiments, cloud cashier system 160 may be used. In use, images of unidentified items 144 captured by any of cameras 114, 116, or 127 as well as suggested items to be altered on the SCL 108 may be presented on cloud cashier system to a human operator for identification. The human operator may be on the store 138 premises or may be remotely located. It should be appreciated that the human operator of cloud cashier system may be a store employee with knowledge of the items 144 sold in store 138 to thereby be able to swiftly resolve unidentified or suggested items 144.

Alternatively, in step 226, a suggested list of items 144 on the SCL 108 that don't appear to be in cart 118, or of additional items 144 suspected to be in cart 118 are provided to shopper 132 via app 134 or via a display (not shown) of scanner 128. Shopper 132 then adjusts the SCL 108 by approving and/or amending the suggestions of cart analyzer 126 and/or removing items 144 from cart 118.

Steps 224 and 226 are repeated until the SCL 108 has been adjusted such that it can be certified as correct (matching cart 118 contents) by cart analyzer 126. In some embodiments, process 200 may proceed directly to step 234 as described below.

In step 228, in some embodiments, the completed SCL 108 as well as supporting data, including but not limited to cart images, shopper route in store, altered items, cart weight, shopper history, and so forth, is forwarded to a verifier system 156 for additional verification of the accuracy of the certified SCL 108 from cart analyzer 126. In step 232, where verifier system 156 does not verify SCL 108 from step 224, such as when the analysis of provided data vs. the provided SCL 108do not match in the analysis of step 230, verifier system returns a suggested list of items 144 on the SCL 108that don't appear to be in cart 118, or of additional items 144 suspected to be in cart 118 to SLB 110. It should be appreciated that the suggested list of step 232 may be different to that of step 226. SLB 110 may then provide the suggested list of items 144 on the SCL 108 that do not appear to be in cart 118, or of additional items 144 suspected to be in cart 118 may be provided to shopper 132 via app 134 or via a display (not shown) of scanner 128. Alternatively or additionally, cloud cashier 160 may be consulted as in step 226. Shopper 132 may then adjust SCL 108 by agreeing with the suggestions of verifier system 156 and/or removing items 144 from cart 118. Steps 230 and 232 are repeated until SCL 108 has been adjusted such that it can be verified as correct (matching cart 118 contents) by verifier system 156. Shopper 132 is then able to proceed to step 234 for authorizing the final SCL 108 and paying.

If, in step 224, or (where verifier system 156 is used) step 230, the provided SCL 108 is verified, then, in step 234, the SCL 108 may be displayed (such as on a display (not shown) of scanner 128, or on app 134) to shopper 132 for review and authorization by shopper 132. Shopper 132 may then pay for the items 144 selected and can then leave store 138. In some embodiments, a payment receipt may immediately be shown on app 134 following completion of payment. In some embodiments, a receipt may be provided to shopper 132 at a later time. In some embodiments, payment in step 226 may be made via app 134 and payment gateway 124. In some embodiments, payment is made via cart scanner 128 and payment gateway 124.

In some embodiments, images from checkout camera 154 may be analyzed by SLB 110 for one or more of: verifying the accuracy of cart analyzer 126 and/or monitoring shopper 132 activity to detect shoplifting activity. In some embodiments, data determined from analysis of checkout camera 154 may be communicated to cart analyzer 126 and/or verifier system 156 for enhancing the accuracy of checkout analyzer 126 and/or verifier system 156.

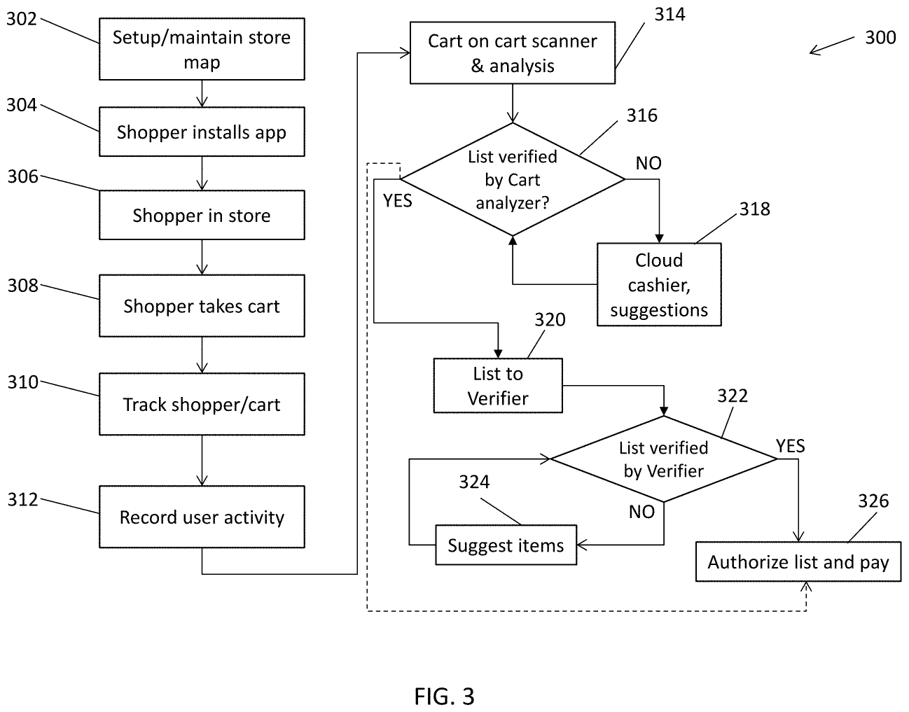

FIG. 3 shows an exemplary flowchart of a process (method) numbered 300 for generating an SCL 108 according to some embodiments. Process 300 utilizes SCL system 100 as described above. Steps 302-310 are the same as steps 202-210 described above.

In step 312, shopper 132 interacts with one or more items 144 from a shelf 142. SLB 110 may record the images from cameras 114 and/or 116 and may use machine vision techniques to identify the shopper activity and the items 144 selected by the shopper 132. Where weighed goods 150 are selected, shelf scales 148 may transmit the removed weight of weighed goods 150 as selected by a shopper 132 to SLB 110. The price of the selected weighed goods 150 may then be calculated and added to SCL 108 in step 314. Where weighed goods 150 are placed on printer scale 152, printer scale 152 may transmit the weight of weighed goods 150 as selected by a shopper 132 and placed on printer scale 152 to SLB 110. The price of the selected weighed goods 150 may then be calculated and added to SCL 108 in step 314. Alternatively, printer scale 152 may print a price label for scanning by app 134 for adding to SCL 108 in step 314. In some embodiments, app 134 may notify shopper 132 of promotions related to items 144 that are positioned near to shopper's 132 current location.

In step 314, shopper 132 reaches a cart scanner 128 and cart analyzer 126 using scanner 128, analyzes cart 118 to determine SCL 108. The analysis by cart analyzer 126 of cart 118 is based on data provided by scanner 128 including loaded cart weight as measured by weight sensor 129, and visual analysis using machine vision techniques of cart 118 by scanner camera 127 to identify items 144. The analysis by cart analyzer 126 of cart 118 may also be based on the route used by shopper 132 during this shop, machine vision analysis of images recorded of the shopper 132 during this shop, shopper 132 historical shopping data, general shopper buying trends, and so forth.

In step 318, in some embodiments, where cart analyzer 126 determines that the SCL 108 is incomplete, i.e.: may not match the contents of cart 118, or where there is uncertainty as to the contents of the cart, for example where a measured weight of the cart exceeds the weight of the identified items 144, cloud cashier system 160 may be used. In use, images of unidentified items 144 captured by any of cameras 114, 116, or 127 as well as suggested items to be altered on the SCL 108 may be presented on cloud cashier system to a human operator for identification. The human operator may be on the store 138 premises or may be remotely located.

Alternatively, in step 318, a suggested list of items 144 on SCL 108 that don't appear to be in cart 118, or of additional items 144 suspected to be in cart 118 are provided to shopper 132 via app 134 or via a display (not shown) of scanner 128. Shopper 132 then adjusts SCL 108 by agreeing with the suggestions of cart analyzer 126 and/or removing items 144 from cart 118.

Steps 316 and 318 are repeated until SCL 108 has been adjusted such that it can be certified as correct (matching cart 118 contents) by cart analyzer 126. In some embodiments, process 300 may proceed directly to step 326 which is the same as step 234 described above. In some embodiments, app 134 may notify shopper 132 of promotions or related purchase information related to items 144 that have already been selected (as per the generated SCL 108).

In step 320, in some embodiments, the completed SCL 108as well as supporting data, including but not limited to cart images, shopper route in store, altered items, cart weight, shopper history, and so forth, is forwarded to a verifier system 156 for additional verification of the accuracy of the certified SCL 108 from cart analyzer 126. In step 324, where verifier system 156 does not verify SCL 108 from step 316, such as when the analysis of provided data vs. the provided SCL 108 do not match as determined in step 322, verifier system returns a suggested list of items 144 on the SCL 108 that don't appear to be in cart 118, or of additional items 144 suspected to be in cart 118 to SLB 110. It should be appreciated that the suggested list of step 324 may be different to that of step 318. SLB 110 may then provide the suggested list of items 144 on the SCL 108that don't appear to be in cart 118, or of the additional items 144 suspected to be in cart 118 to shopper 132 via app 134 or via a display (not shown) of scanner 128. Alternatively or additionally, cloud cashier 160 may be consulted as in step 318. Shopper 132 may then adjust SCL 108 by agreeing with the suggestions of verifier system 156 and/or removing items 144 from cart 118. Steps 322 and 324 are repeated until SCL 108 has been adjusted such that it can be verified as correct (matching cart 118 contents) by verifier system 156. Shopper 132 is then able to proceed to step 326 for authorizing the final SCL 108 and paying.

Step 326 is the same as step 234 described above.

In some embodiments, images from checkout camera 154 may be analyzed by SLB 110 for one or more of: verifying the accuracy of cart analyzer 126 and/or monitoring shopper 132 activity to detect shoplifting activity. In some embodiments, data determined from analysis of checkout camera 154 may be communicated to cart analyzer 126 and/or verifier system 156 for enhancing the accuracy of checkout analyzer 126 and/or verifier system 156.

In some embodiments, SLB 110 continually or periodically analyzes behavior of all shoppers to determine buying trends, common shopping routes in-store, shopper preferences, item interaction patterns and so forth.

Unless otherwise defined, all technical and scientific terms used herein have the same meaning as commonly understood by one of ordinary skill in the art. The materials, methods, and examples provided herein are illustrative only and not intended to be limiting.

Implementation of the method and system of the present disclosure involves performing or completing certain selected tasks or steps manually, automatically, or a combination thereof. Moreover, according to actual instrumentation and equipment of preferred embodiments of the method and system of the present disclosure, several selected steps could be implemented by hardware or by software on any operating system of any firmware or a combination thereof. For example, as hardware, selected steps of the disclosure could be implemented as a chip or a circuit. As software, selected steps of the disclosure could be implemented as a plurality of software instructions being executed by a computer using any suitable operating system. In any case, selected steps of the method and system of the disclosure could be described as being performed by a data processor, such as a computing platform for executing a plurality of instructions.

As used herein the terms “machine learning”, “computer vision” or “artificial intelligence” refer to use of algorithms on a computing device that parse data, learn from the data, and then make a determination or generate data, where the determination or generated data is not deterministically replicable (such as with deterministically oriented software as known in the art).

Although the present disclosure is described with regard to a “computing device”, a “computer”, or “mobile device”, it should be noted that optionally any device featuring a data processor and the ability to execute one or more instructions may be described as a computer or computing device, including but not limited to any type of personal computer (PC), a server, a distributed server, a virtual server, a cloud computing platform, a cellular telephone, a cart-mounted tablet, an IP telephone, a smartphone, or a PDA (personal digital assistant). Any two or more of such devices in communication with each other may optionally comprise a “computer network”.

It should be understood that where the claims or specification refer to “a” or “an” element, such reference is not to be construed as there being only one of that element.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination.

While this disclosure describes a limited number of embodiments, it will be appreciated that many variations, modifications and other applications of such embodiments may be made. The disclosure is to be understood as not limited by the specific embodiments described herein, but only by the scope of the appended claims.

1. A system for generating a shopping checkout list (SCL) of items selected by a shopper in a store comprising:
a) in-store security cameras; and
b) a shopping list builder (SLB) configured to analyze images from the in-store security cameras to determine selection of items by a shopper and to generate the SCL.

2. The system of claim 1, further comprising a cart scanner and a cart analyzer configured to verify the generated SCL based on the data received from the cart scanner.

3. The system of claim 2, wherein selected items are placed in a cart to form contents of the cart and wherein the configuration to verify the generated SCL comprises a configuration to analyze contents of the cart by the cart analyzer to determine whether the contents of the cart match the generated SCL.

4. The system of claim 3, wherein the cart comprises a cart ID, wherein the cart is tracked by the SLB by identification of the cart ID, and wherein the cart is associated with the shopper based on proximity and usage of the cart by the shopper.

5. The system of claim 4, wherein, when the contents of the cart do not match the generated SCL, the cart analyzer is configured to suggest items that may be in the cart and which do not appear on the SCL.

6. The system of claim 4, wherein, when the contents of the cart do not match the generated SCL, the cart analyzer is configured to forward suggestions for items that may be in the cart and which do not appear on the SCL to a cloud cashier.

7. The system of claim 2, wherein the SLB comprises a store mapper and wherein the determined selection of items is limited by items in the vicinity of the shopper in the store as provided by the store mapper.

8. The system of any one of claims 1-7, wherein the cart scanner includes a camera and/or a weight sensor for providing data for analysis of the cart by the cart analyzer.

9. (canceled)

10. The system of any one of claims 1-7, further comprising a verifier system configured to verify the generated checkout list.

11. The system of any one of claims 1-7, further comprising a shelf scale configured to transmit to the SLB a removed weight of weighed goods selected by the shopper.

12. The system of any one of claims 1-7, further comprising a printer scale configured to transmit to the SLB the weight of weighed goods as selected by a shopper and placed on the printer scale.

13. A system for generating a shopping checkout list (SCL) of items selected by a shopper in a store comprising:
a) a plurality of in-store security cameras;
b) a cart scanner;
c) a cart analyzer configured to generate a SCL based on the data received from the cart scanner; and
d) a shopping list builder (SLB) configured to record images from the security cameras of activity of the shopper in the store to form recorded images,
wherein, when the SLB requires verification of an item in the generated SCL, the SLB is further configured to analyze the recorded images to determine selection of an item by a shopper to thereby verify whether the item is on the SCL.

14. The system of claim 13, wherein, when the SCL is determined to be incomplete, the cart analyzer is configured to suggest items that may be in the cart that do not appear on the SCL.

15. The system of claim 13, wherein, when the SCL is determined to be incomplete, the cart analyzer is configured to forward suggestions for items that may be in the cart that do not appear on the SCL to a cloud cashier.

16. The system of any one of claims 13-15, wherein the cart scanner includes a camera and/or a weight sensor for providing data for analysis of the cart.

17. The system of claim 16, wherein analysis of the images from the security cameras and/or the scanner camera is performed using machine vision techniques.

18. The system of any one of claims 13-15, further comprising a verifier system configured to verify the generated checkout list.

19. (canceled)

20. A method for generating a shopping checkout list (SCL) of items selected by a shopper in a store comprising:
a) by a shopper, selecting items for purchase;
b) by a shopping list builder (SLB), recording images from security cameras of activity of the shopper in the store to form recorded images;
c) providing the selected items to a cart scanner for scanning;
d) determining by a cart analyzer of determined selected items based on scanning data from the cart scanner;
e) forming a SCL based on the determined selected items; and
f) when the SLB requires verification of a determined selected item in the generated SCL, analyzing by the SLB of the recorded images to determine selection of the determined selected item by a shopper to thereby verify the determined selected item on the SCL.

21. The method of claim 20, wherein, when the SCL is determined to be incomplete, suggesting items by the cart analyzer that may selected items that do not appear on the SCL.

22. The system of claim 20, wherein, when the SCL is determined to be incomplete, forwarding suggestions by the cart analyzer for items that may be selected items that do not appear on the SCL to a cloud cashier.
